(19) United States
(12) Patent Application Publication
(10) Pub. No.: US 2018/0170146 A1
(43) Pub. Date: Jun. 21, 2018

(54) HVAC SYSTEM

(71) Applicant: Air International (US) Inc., Auburn Hills, MI (US)

(72) Inventors: Richard Hoyle, Clarkston, MI (US); Wayne Wright, Goodrich, MI (US)

(21) Appl. No.: 15/381,599

(22) Filed: Dec. 16, 2016

(51) Int. Cl. B60H 1/00; F04D 17/16; F04D 29/30; F04D 25/02; F04D 29/053

(52) U.S. Cl. CPC B60H 1/00471; F04D 17/16; F04D 29/053; F04D 25/02; F04D 29/30

(57) ABSTRACT

An HVAC system according to an example of the present disclosure includes a blower rotatable about an axis that has a first axial end and a second axial end opposite the first axial end. A hub is positioned to divide the blower into a first section for receiving a first fluid flow and a second section for receiving a second fluid flow fluidly isolated from the first fluid flow. The blower is configured to receive the first and second fluid flows in through the first axial end

### BACKGROUND

Modern vehicles include heating, ventilation, and air conditioning (HVAC) systems for improving passenger comfort.

The present disclosure relates generally to an HVAC assembly, and more particularly to a double-layer flow type vehicular HVAC system that conditions both inside and outside air.

### SUMMARY

An HVAC system according to an example of the present disclosure includes a blower rotatable about an axis that has a first axial end and a second axial end opposite the first axial end. A hub is positioned to divide the blower into a first section for receiving a first fluid flow and a second section for receiving a second fluid flow fluidly isolated from the first fluid flow. The blower is configured to receive the first and second fluid flows in through the first axial end.

In a further embodiment of any of the foregoing embodiments, the first fluid flow is outside air and the second fluid flow is inside air from a vehicle passenger compartment.

In a further embodiment of any of the foregoing embodiments, the blower is configured to pass the first fluid flow and the second fluid flow out of the blower in a radially outward direction.

A further embodiment of any of the foregoing embodiments includes a second hub having a radially outer surface configured to guide the second fluid flow.

A further embodiment of any of the foregoing embodiments includes a motor and a shaft driven by the motor. The second hub is configured to fluidly separate the second airflow from the motor and the shaft.

In a further embodiment of any of the foregoing embodiments, the second hub is generally bell-shaped.

In a further embodiment of any of the foregoing embodiments, the hub extends radially outward as it extends from the first axial end toward the second axial end.

In a further embodiment of any of the foregoing embodiments, the first fluid flow is received across a first surface of the hub and the second fluid flow is received across a second surface of the hub.

In a further embodiment of any of the foregoing embodiments, the first section is bound by an opening at the first axial end, the first surface of the hub, and a plurality of blades.

In a further embodiment of any of the foregoing embodiments, the second section is bound by a second opening at the first axial end, the second surface of the hub, a surface of a second hub, and a second plurality of blades.

An HVAC system according to an example of the present disclosure includes a blower rotatable about an axis that has a first axial end and a second axial end opposite the first axial end. A first hub is positioned to divide the blower into a first section for receiving a first fluid flow and a second section for receiving a second fluid flow fluidly isolated from the first fluid flow. The blower is configured to receive the first and second fluid flows in through the first axial end. A second hub is positioned to separate the second section from a third section such that the second fluid flow is fluidly isolated from the third section.

A further embodiment of any of the foregoing embodiments includes an HVAC unit in fluid communication with the blower.

A further embodiment of any of the foregoing embodiments includes a first housing in fluid communication with the HVAC unit and configured to receive the first fluid flow exiting the fan. A second housing is in fluid communication with the HVAC unit and configured to receive the second fluid flow exiting the fan, while the first housing and the second housing are fluidly separate.

A further embodiment of any of the foregoing embodiments includes a first fluid flow compartment having a first door and a second fluid flow compartment fluidly separate from the first fluid flow compartment and having a second door. The blower is configured such that the first fluid flow is received into the blower through the first fluid flow compartment, and the second fluid flow is received into the blower through the second fluid flow compartment.

In a further embodiment of any of the foregoing embodiments, the first fluid flow compartment and the second fluid flow compartment are disposed at the first axial end of the fan.

In a further embodiment of any of the foregoing embodiments, the first fluid flow is outside air and the second fluid flow is inside air from a vehicle passenger compartment.

In a further embodiment of any of the foregoing embodiments, the second hub is generally bell-shaped.

In a further embodiment of any of the foregoing embodiments, the first hub extends radially outward as it extends from the first axial end toward the second axial end.

These and other features may be best understood from the following specification and drawings, the following which is a brief description.

### BRIEF DESCRIPTION OF THE DRAWINGS

FIG. 1 schematically illustrates an example HVAC system.

FIG. 2 illustrates a sectional view of an example blower assembly.

FIG. 3 illustrates a sectional view of an example blower assembly.

FIG. 4 illustrates a sectional view of an example blower assembly.

FIG. 5 schematically illustrates a sectional view of an example blower assembly.

FIG. 6 illustrates a perspective view of an example blower assembly with outer housings.

FIG. 7 illustrates a perspective view of an example inlet assembly.

### DETAILED DESCRIPTION

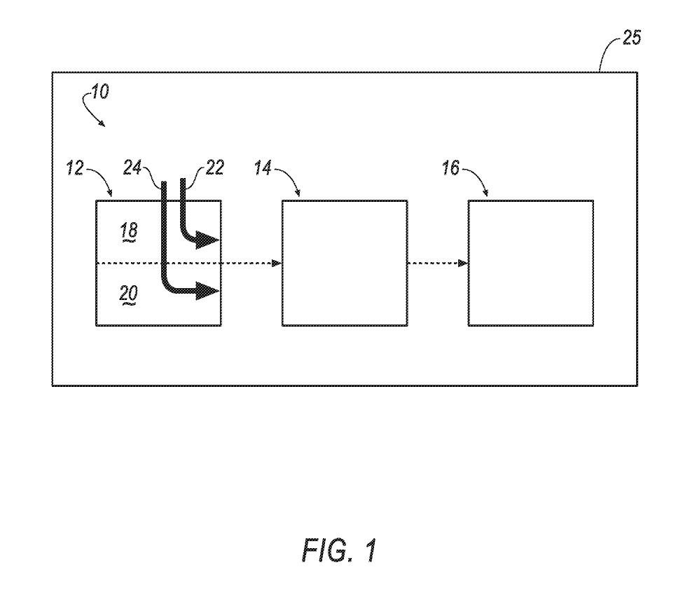

FIG. 1 schematically illustrates an HVAC system 10 includes a blower assembly 12 in fluid communication with an HVAC unit 14 adapted to condition airflow for modifying a temperature within a vehicle passenger compartment 16, as shown schematically. The blower assembly 12 includes a blower section 18 for drawing in and passing a fluid flow 22 and a separate blower section 20 for drawing in and passing a fluid flow 24. In one example, one of the fluid flows 22, 24 is outside air, while the other of the fluid flows 22, 24 is inside air recirculated from the passenger compartment 16.

In one example, the HVAC system 10 is a double-layer system positioned inside a vehicle 25 (shown schematically) and is capable of conditioning either of the fluid flows 22, 24 individually or both of the fluid flows 22, 24 at the same time.

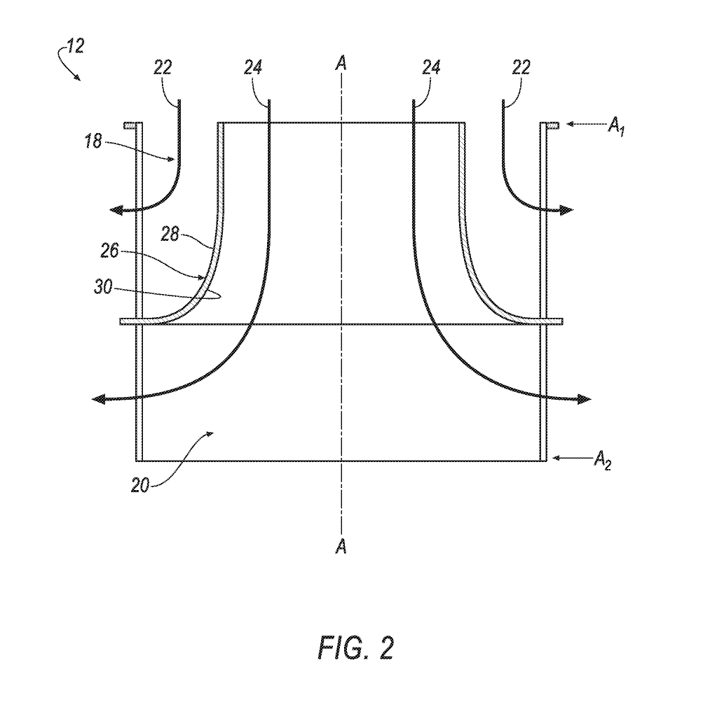

FIG. 2 shows an example of a blower assembly 12 rotatable about an axis A. A hub 26 fluidly separates the section 18 from the section 20. The hub 26 includes a radially outer surface 28 and a radially inner surface 30. The radially outer surface 28 directs the fluid flow 22 drawn into the blower assembly 12 through an axial end A1 radially outward of the section 18 of the blower assembly 12. The fluid flow 24 drawn into section 20 of the blower assembly 12 through the axial end A1 flows along the radially inner surface 30 and radially outward of the section 20 of the blower assembly 12.

The hub 26 fluidly isolates the fluid flows 22, 24 from one another, so that, as the fluid flows 22, 24 enter and exit the blower 12, they do not mix. As one example, the hub 26 separates inside air of the passenger compartment 16 from outside air from outside the vehicle 25.

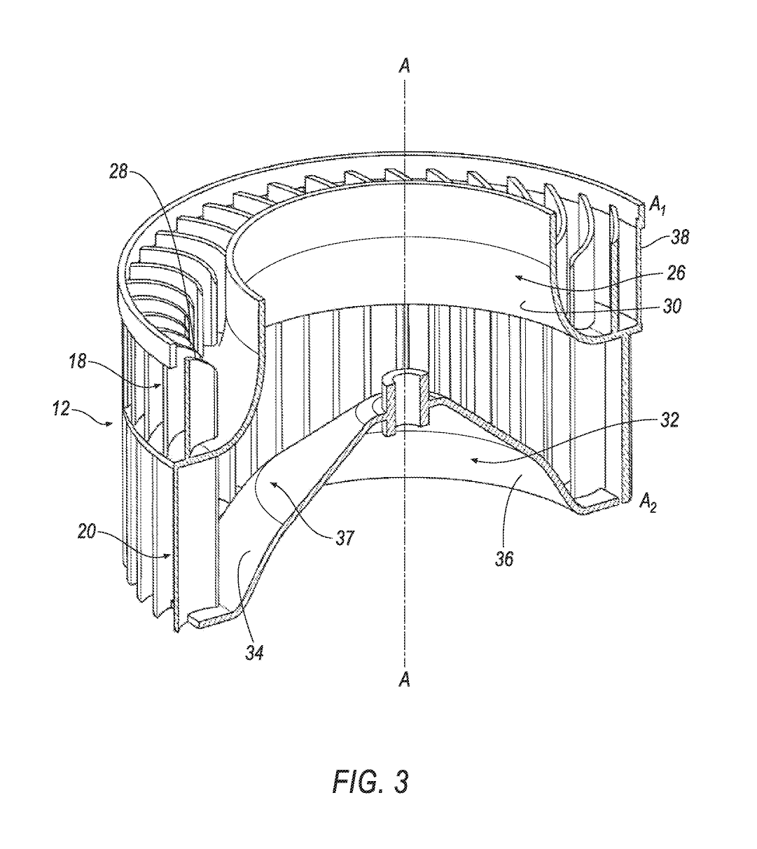

Referring to FIG. 3, with continued reference to FIG. 2, an example blower assembly 12 may include an additional hub 32, at least a section of which is generally radially inward of the hub 26. The hub 32 has a radially outer surface 34 and a radially inner surface 36. In one example, the hub 32 is generally bell-shaped. As shown in the example, a main body portion 37 of the bell-shaped hub 32, although axially offset from the hub 26, is radially inward of the hub 26.

The radially outer portion of the blower assembly 12 is defined by a plurality of axially extending blower blades 38 for drawing air through the blower assembly 12. The blower blades 38 define the radially outer boundaries of the sections 18 and 20. The blower blades 38 of the section 18 and the blower blades 38 of the section 20 may be circumferentially aligned or may be circumferentially spaced differently.

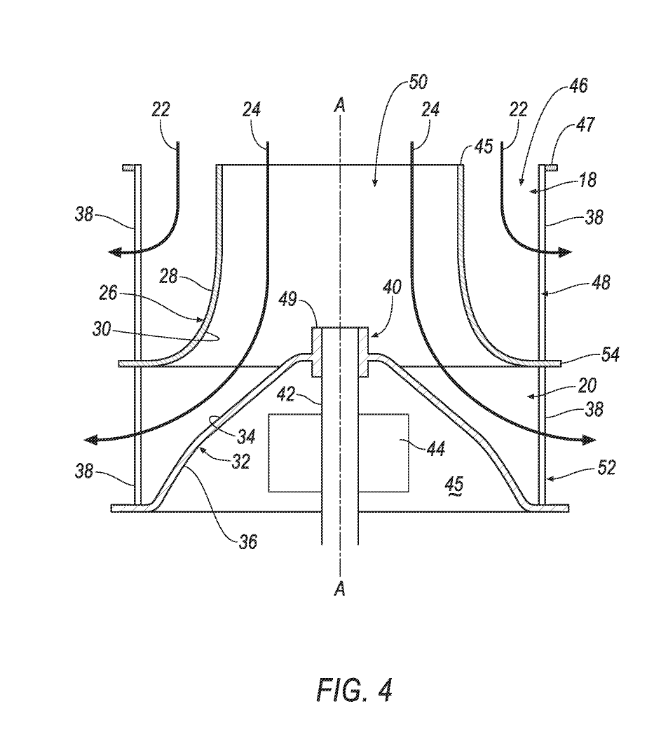

Referring to FIG. 4, a motor 44 drives a shaft 42 that engages an engagement portion 40 of the hub 32, such that the motor 44 drives the assembly 12. The blades 38, through their attachment to the hub 32, rotate about the axis A though the shaft 42. In the example, the entire assembly 12 is driven by motor 44 such that fluid flows 22, 24 are drawn through the assembly concurrently. The engagement portion 40 of the hub 32 is located at the axial end of the hub 32, and the blades 38 are fixed to or monolithic with the hub 32 at the axial end A2; however, other locations are contemplated. The hub 32 fluidly isolates the fluid flow 24 from the motor 44 in section 45 of the section 20, such that the radially outer surface 34 of the hub 32 guides the fluid flow 24 radially outward of the section 20. The blades 38 of both sections 18, 20 are fixed to or monolithic with the hub 26, such that the shaft 42 and motor 44 drive the entire blower assembly 12.

An axial end portion 45 of the hub 26 and a lip section 47 of the assembly 12 define an opening 46 at the axial end A1 where the fluid flow 22 is drawn into section 18 of the blower assembly 12. The fluid flow 22 travels from the end A1 toward the end A2 and radially outward through an opening 48 defined between adjacent blades 38 at the radially outer portion of the section 18.

The axial end 45 of the hub 26 establishes an opening 50 for the fluid flow 24 to be drawn into the blower assembly 12. The fluid flow 24 flows from the axial end A1 toward the axial end A2 and radially outward through an opening 52 defined between adjacent blades 38 at the radially outer portion of the section 20. The fluid flow 24 flows between the radially outer surface 34 of the hub 32 and the radially inner surface 30 of the hub 26.

In an example, the opening 52 of the section 20 and the opening 48 of the section 18 are separated by a radially extending portion 54 of the hub 26 that intersects the plurality of blades 38. From the axial end 45 to the radially extending portion 54, the hub 26 generally extends radially outward as it extends from the axial end A1 toward the axial end A2 of the blower assembly 12. The hub 32 is generally bell-shaped and the blades 38 define a generally cylindrical shape of the blower assembly 12. However, other shapes are also contemplated.

The opening 46, the radially outer surface 28 of the hub 26, and the opening 48 defined between the blades 38 define the general boundaries of section 18 of the blower assembly 12. The opening 50, the radially inner surface 30 of the hub 26, the opening 52 defined between the blades 38, and the surface 34 of the hub 32 define the general boundaries of section 20 of the blower assembly 12.

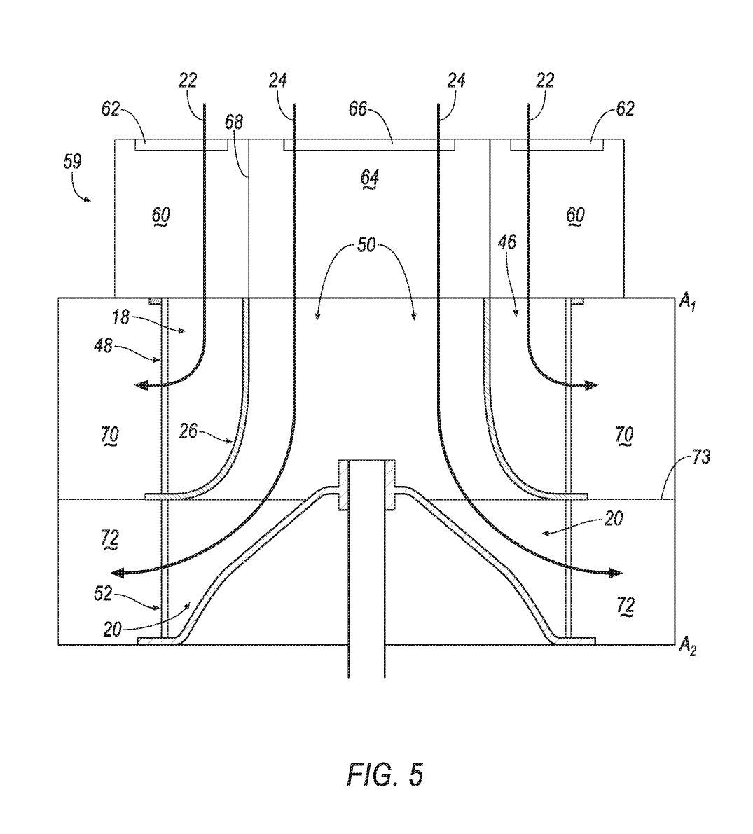

Referring to FIG. 5, the blower assembly 12 communicates the fluid flows 22, 24 separately through the blower assembly 12. The fluid flows 22, 24 may therefore be sourced from fluidly separate sections adjacent an axial end A1 of the blower assembly 12.

For example, an inlet assembly 59 may be located at the axial end A1 of the blower assembly 12. The fluid flow 22 may enter one or more compartment 60 through one or more doors 62 then enter into the blower section 18 through the opening 46, and then exit the blower section 18 radially outwardly through the opening 48 into a housing 70. The fluid flow 24 enters a compartment 64 through a door 66 and is drawn into the blower through an opening 50 at the axial end A1 of the blower assembly 12 and out of the blower at the opening 52 into a housing 72.

In the example, each of the compartments 60, 64 is located at the axial end A1 of the blower assembly 12 and extend in the axial direction away from the axial end A1 of the blower assembly 12. The airflows 22 and 24 (see FIG. 1) thus both enter the blower assembly 12 through the same axial side A1. One advantage of having the air inlet assembly 30 at a single axial end of the blower is the saving of space inside the vehicle over an assembly that would require separate air inlets on each axial side of the blower. Another advantage is that the disclosed air inlet assembly 30 provides decreased pressure drop because the path of the airflows (both through the same axial side) is more direct than that of prior art systems, resulting in a more efficient HVAC system.

In the example, the housing 70 and the housing 72 are fluidly separate, and the compartment 60 and the compartment 64 are fluidly separate. The compartment 60 and the compartment 64 are fluidly separated by a partition 68, and the housings 70 and 72 are fluidly separated by a partition 73. For example, the partitions 68, 73 are dividers or walls or other structures through which fluid cannot pass. The partition 68 may be substantially aligned with the hub 26 at the axial end A1. The partition 73 may be substantially aligned with the hub 26 at the radial end of the hub 26. The fluid flows 22, 24 therefore remain fluidly separate before, during, and after passing through the blower assembly 12.

In an example, the fluid flow 24 may be recirculated air from the passenger compartment 16 (see FIG. 1), and the fluid flow 22 may be air from outside the vehicle. An opposite arrangement is also contemplated, in which the fluid flow 22 is recirculated air from the passenger compartment 16 (see FIG. 1), and the fluid flow 24 is air from outside the vehicle. Additionally, both fluid flows 22, 24 may be outside air or both fluid flows 22, 24 may be recirculated air.

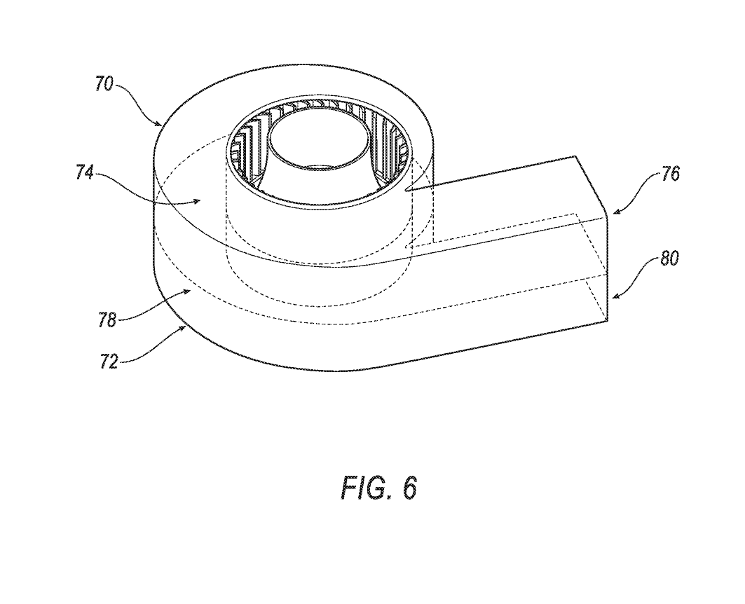

Referring to FIG. 6, with continued reference to FIGS. 1-5, the housing 70 includes a section 74 radially outward of the blower assembly 12 and an outlet section 76 fluidly downstream of the section 74. The fluid flow through housing 70 travels through the section 74 and out the outlet section 76, which may be in communication with the HVAC unit 14.

Similarly, housing 72 includes a section 78 radially outward of the blower assembly 12 and an outlet section 80 fluidly downstream of the section 78. The fluid flow through the housing 72 travels through the section 78 and out of the outlet section 80, which may be in communication with the HVAC unit 14. In one example, the housing 70 and the housing 72 have substantially the same shape.

Referring to FIGS. 5 and 6, in an example, the fluid flow 24 may be recirculated air from the passenger compartment 16 (see FIG. 1), and the fluid flow 22 may be air from outside the vehicle. These fluid flows may come through different inlets in the inlet assembly 59, with which each of the compartments 60, 64 is in communication with. The fluid flow 24 flows through section 20 of the blower assembly 12 and into housing 72 associated with lower or floor vents in the vehicle cabin. Recirculated air often has higher humidity than fresh air, which makes it less desirable for the upper and defrost vents associated with the blower section 18 and housing 70. Higher humidity in the air in these upper sections may lead to increased fogging in the vehicle glass. The example HVAC systems disclosed herein are thus compact and efficient systems that keep recirculated air isolated from fresh air before, during, and after flowing through the blower assembly 12.

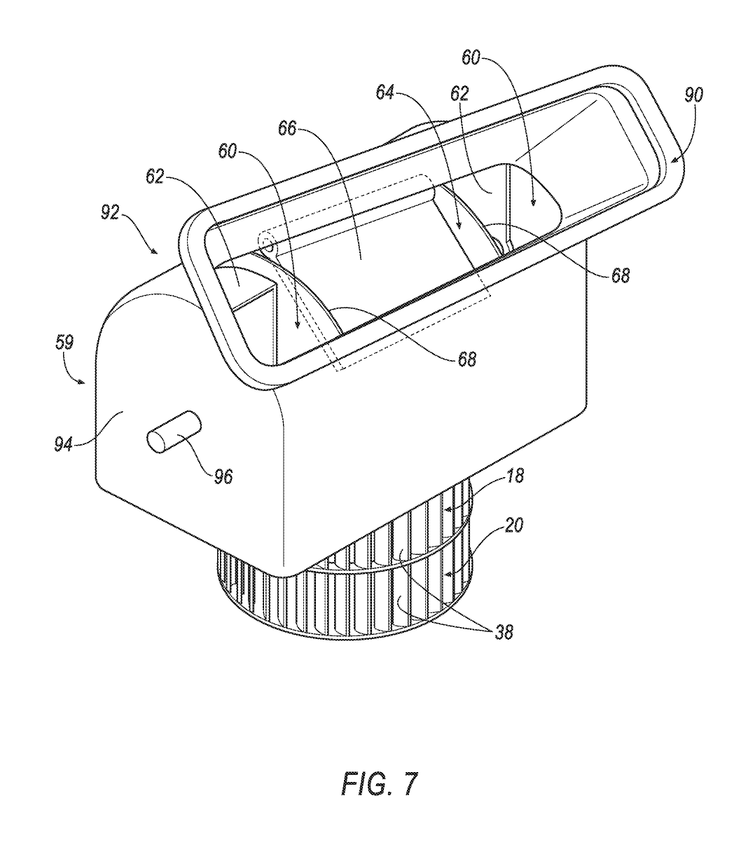

FIG. 7 illustrates an example inlet assembly 59. The first inlet 90 is located at the front side of FIG. 7, while the second inlet 92 is located at the opposite side of the inlet assembly 59, at the back side of FIG. 7. Each compartment 60, 64 is in fluid communication with each inlet 90, 92. A partition 68 encloses the fluid compartment 64 and fluidly separates the compartment 60 from the compartment 64. In the example, the partition 68 is enclosed by the outer casing 94 of the inlet assembly 59 that encloses the compartment 60. With reference to FIGS. 1-5, for example, the fluid flow 22 may be from one of the inlets 90, 92, and the fluid flow 24 may be from the other of the inlets 90, 92. As another example, both fluid flows 22, 24 may be from the same inlet 90 or 92.

In the example, the doors 62 are shell-style doors, while the door 66 is a flap-style door. One of ordinary skill in the art having the benefit of this disclosure would recognize that other door styles that can prevent airflow may be utilized, including, for example, that the door 66 may be a shell-style door and/or the doors 62 may be flap-style doors.

In the example, the door 66 and the compartment 64 are substantially centrally located within the inlet assembly 59, and located between the doors 62. Such an arrangement allows for even airflow into the blower assembly 12. The centrally located door 66 and compartment 64 create a direct airflow path into the blower section 20, while the doors 62 and compartment 60 on either said of the door 66 and compartment 62 create a direct airflow path into the blower section 18. This arrangement results in even and direct airflow through the blower assembly 12 that results in decreased pressure drop.

The doors 62 may be rotatable about a common shaft 96, such that the doors 62 operate to allow fluid flow into the compartment 60 from one of the inlets 90, 92 at a time. In the setting shown, the doors 62, 66 are positioned such that compartment 64 is closed off to the inlet 90 and open to the inlet 92, while compartment 60 is closed off to the inlet 92 and open to inlet 90.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. An HVAC system comprising:
a blower rotatable about an axis and having a first axial end and a second axial end opposite the first axial end; and
a hub positioned to divide the blower into a first section for receiving a first fluid flow and a second section for receiving a second fluid flow fluidly isolated from the first fluid flow, the blower configured to receive the first and second fluid flows in through the first axial end.

2. The HVAC system as recited in claim 1, wherein the first fluid flow is outside air, and the second fluid flow is inside air from a vehicle passenger compartment.

3. The HVAC system as recited in claim 1, wherein the blower is configured to pass the first fluid flow and the second fluid flow out of the blower in a radially outward direction.

4. The HVAC system as recited in claim 1, comprising:
a second hub having a radially outer surface configured to guide the second fluid flow.

5. The HVAC system as recited in claim 4, comprising:
a motor;
a shaft driven by the motor, wherein the second hub is configured to fluidly separate the second airflow from the motor and the shaft.

6. The HVAC system as recited in claim 4, wherein the second hub is generally bell- shaped.

7. The HVAC system as recited in claim 1, wherein the hub extends radially outward as it extends from the first axial end toward the second axial end.

8. The HVAC system as recited in claim 1, wherein the first fluid flow is received across a first surface of the hub, and the second fluid flow is received across a second surface of the hub.

9. The HVAC system as recited in claim 8, wherein the first section is bound by an opening at the first axial end, the first surface of the hub, and a plurality of blades.

10. The HVAC system as recited in claim 9, wherein the second section is bound by a second opening at the first axial end, the second surface of the hub, a surface of a second hub, and a second plurality of blades.

11. An HVAC system comprising:
a blower rotatable about an axis and having a first axial end and a second axial end opposite the first axial end;
a first hub positioned to divide the blower into a first section for receiving a first fluid flow and a second section for receiving a second fluid flow fluidly isolated from the first fluid flow, the blower configured to receive the first and second fluid flows in through the first axial end; and
a second hub positioned to separate the second section from a third section, such that the second fluid flow is fluidly isolated from the third section.

12. The HVAC system as recited in claim 11, comprising:
an HVAC unit in fluid communication with the blower.

13. The HVAC system as recited in claim 12, comprising:
a first housing in fluid communication with the HVAC unit and configured to receive the first fluid flow exiting the fan;
a second housing in fluid communication with the HVAC unit and configured to receive the second fluid flow exiting the fan, wherein the first housing and the second housing are fluidly separate.

14. The HVAC system as recited in claim 11, comprising:
a first fluid flow compartment having a first door; and
a second fluid flow compartment fluidly separate from the first fluid flow compartment and having a second door, wherein the blower is configured such that
the first fluid flow is received into the blower through the first fluid flow compartment, and
the second fluid flow is received into the blower through the second fluid flow compartment.

15. The HVAC system as recited in claim 14, wherein the first fluid flow compartment and the second fluid flow compartment are disposed at the first axial end of the fan.

16. The HVAC system as recited in claim 14, wherein the first fluid flow is outside air, and the second fluid flow is inside air from a vehicle passenger compartment.

17. The HVAC system as recited in claim 11, wherein the second hub is generally bell-shaped.

18. The HVAC system as recited in claim 11, wherein the first hub extends radially outward as it extends from the first axial end toward the second axial end.
